(19) United States
(12) Patent Application Publication
(10) Pub. No.: US 2008/0304451 A1
(43) Pub. Date: Dec. 11, 2008

(54) METHOD TO ALLOW HAND-OFF OF A CDMA MOBILE FROM IMS FEMTOCELL TO CIRCUIT MSC

(75) Inventor: Robin Jeffrey Thompson, Batavia, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies, Inc., Murray Hill, NJ (US)

(21) Appl. No.: 11/758,557

(22) Filed: Jun. 5, 2007

(51) Int. Cl. H04Q 7/00; H04Q 7/20

(52) U.S. Cl. 370/331; 370/342; 455/436

(57) ABSTRACT

A method for hand-off of a cell division multi-access mobile from an internet protocol base network to a circuit mobile switching center is disclosed. The system includes determining whether a hand-off is appropriate based at least in part on signal strength of a call for a mobile unit. The method continues with sending a message indicating that the mobile identification of the mobile unit and a target cell locating the circuit identification of a circuit that is available to support a hand-off. The method continues on with allocating the circuit and reconfiguring the mobile unit to a macrocell (CDMA access network) and legacy MSC via the circuit.

### BACKGROUND OF THE DISCLOSURE

This disclosure relates to a method and apparatus and method for converting a signal in one network to another. More particularly, this disclosure relates to a method and apparatus to allow a hand-off of a Code Divisional Multi-Access (CDMA) mobile from an Internet protocol Multimedia Subsystem (IMS) base transceiver system (BTS) (e.g., femtocell) to a circuit Mobile Switching Center (MSC).

While the disclosure is particularly directed to telecommunications and thus will be described with specific reference thereto, it will be appreciated that the disclosure may have usefulness in other fields and applications. For example, the disclosure may be used in a variety of data transfer systems in order to support the gradual migration from one network entity to another, thereby allowing users to utilize IMS systems from their home or business. This will support service providers in investing more energy in future IMS technology.

By way of background CDMA mobiles are in use all over the world. Many people use these handsets in order to transfer voice and data through a well established radio network. Currently, there are many methods for configuring voice path handoffs across the CDMA radio network.

The IMS/Session Initiation Protocol (SIP) based network is an internet based network that supports many other types of handsets. These handsets include Voice over Internet Protocol (VoIP) and other methods to transfer data and voice in real time applications across the internet protocol (IP) network. Although the IMS network is less commonly used in order to transfer voice, it is gaining popularity over other networks. Currently in the industry there is not effective way to utilize a CDMA mobile over the IMS network. The IMS network may not have the coverage area of a legacy cell base network. Therefore, if a user were to use their CDMA mobile in order to make an IMS based call, the signal would be lost if it left the range of the base transceiver system, i.e. femtocell. There is a need in the industry for a system and method that allows a user of a CDMA mobile to seamlessly transfer the signal to another network, i.e. a macrocell in the legacy MSC network.

There is also a need in the industry for a system and method for the reconfiguration of the voice path through an IMS network and connecting it to the circuit base network seamlessly.

The present invention contemplates a new and improved system and method that resolves the above-referenced difficulties and others.

This application is related to U.S. application Ser. No. ______, filed Jun. 1, 2007, entitled “SESSION INITIATION PROTOCOL/INTERNET PROTOCOL MULTIMEDIA SUBSYSTEM BASED ARCHITECTURE FOR SUPPORTING 3G1x VOICE/DATA”, Inventors Burgess, Clark, Freeburg, Ong, Palamara, Rabourn, Thompson and Wierzbicki, Attorney Docket No. Burgess 15-4-3-1-8-2-26-19/LUTZ 2 00527 and U.S. application Ser. No. ______, filed Jun. 1, 2007, entitled “METHOD AND APPARATUS TO ALLOW HAND-OFF FROM A MACROCELL TO A FEMTOCELL”, Inventors Burgess and Thompson, Attorney Docket No. Burgess 14-25/LUTZ 200526. These applications are hereby incorporated by reference.

### SUMMARY OF THE INVENTION

A system and method that allows a hand-off of a CDMA mobile from IMS BTS to circuit MSC is disclosed. This disclosure will allow the conversion of a call that is currently on the IMS network to be carried and processed seamlessly to the circuit based MSC network. The disclosure allows for the migration without changing or manipulating the mobile unit. This disclosure also allows for supplementary services to take place after the hand-off has occurred.

In one aspect of the disclosure this method includes determining whether a hand-off is appropriate based at least in part upon signal strength of a call for a mobile unit, sending a message indicating a mobile identification for the mobile unit and a target cell, locating a circuit identification of a circuit that is available to accept a hand-off, allocating the circuit and reconfiguring the mobile unit to a cell divisional multi-access network via the circuit.

In accordance with another aspect of the present disclosure, the method includes that the mobile identification is an electronic serial number.

In accordance with another aspect of the present disclosure, the method includes that the signal strength includes monitoring cells on a neighbor list.

In accordance with another aspect of the present disclosure, the method includes maintaining the active call while the hand-off takes place.

In accordance with another aspect of the present disclosure, the method includes that the mobile unit be roaming at the time of the hand-off.

In accordance with yet another aspect of the present disclosure, the method includes providing supplemental features through a target mobile switching center.

In accordance with another aspect of the present disclosure, the method includes that the supplemental features include three way calling.

In accordance with yet another aspect of the present disclosure, the method includes that the supplemental features include call waiting.

In accordance with another aspect of the present disclosure, the method includes that the sent message be a session initiation protocol message.

In accordance with another aspect of the present disclosure, the method further includes releasing the call once the call session is complete and signaling the release.

In accordance with another aspect of the present disclosure, the method further includes transport of short message service message between the anchor MSC and the target MSC subsequent to an inter system hand-off

In accordance with another aspect of the present disclosure, the system for a hand-off in a CDMA mobile from the IP based network to a circuit MSC comprises a hand-off application server that implements a hand-off procedure including reconfiguring a call through an IP network to connect to an intersystem circuit and initiating a reservation for a circuit by sending an invite message and a media gateway configured to receive the invite message from the hand-off application server, reserve the circuit for the hand-off and signal back to the hand-off application server that the reservation is complete.

In accordance with another aspect of the present disclosure, the system further includes a BTS that receives measurement messages and based at least in part on a threshold sends a signal to the hand-off application server that initiates a hand-off procedure.

In accordance with yet another aspect of the present disclosure, the system includes a feature server configured to facilitate supplemental services to the call.

In accordance with another aspect of the present disclosure, the system includes that supplemental features include call waiting.

In accordance with another aspect of the present disclosure, the system includes that supplemental features include three way calling.

In accordance with yet another aspect of the present disclosure, a method for facilitating a hand-off procedure includes monitoring radio signal strength from neighbor cells and a communication cell, determining the need for a hand-off based at least in part on radio signal strength, signaling a hand-off initiation message to a hand-off application server, reserving a circuit for the hand-off, the circuit being between an anchor mobile switching center in an IMS and a target MSC in a legacy based network and reconfiguring a path through the circuit.

In accordance with another aspect of the present disclosure, the system includes that the need be based at least in part on radio signal strength and a predetermined threshold.

In accordance with another aspect of the present disclosure, the method includes that the hand-off initiation method is a SIP message.

In accordance with yet another aspect of the present disclosure, the method includes that the path be a voice path.

### DETAILED DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

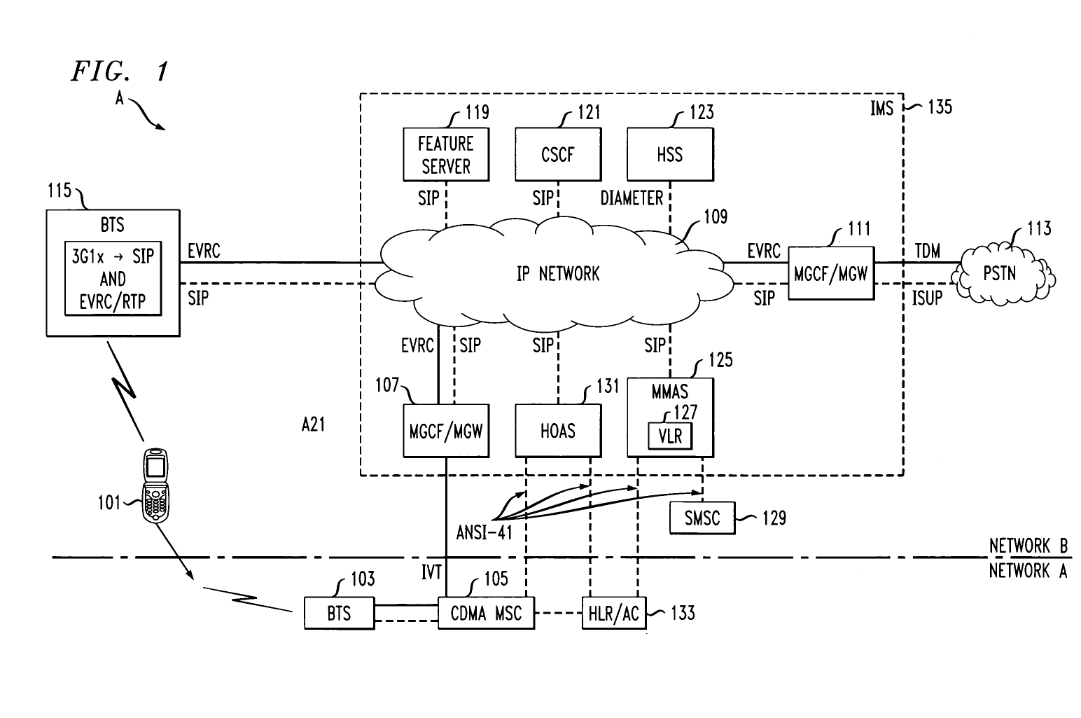

FIG. 1 illustrates a portion of the overall communication network.

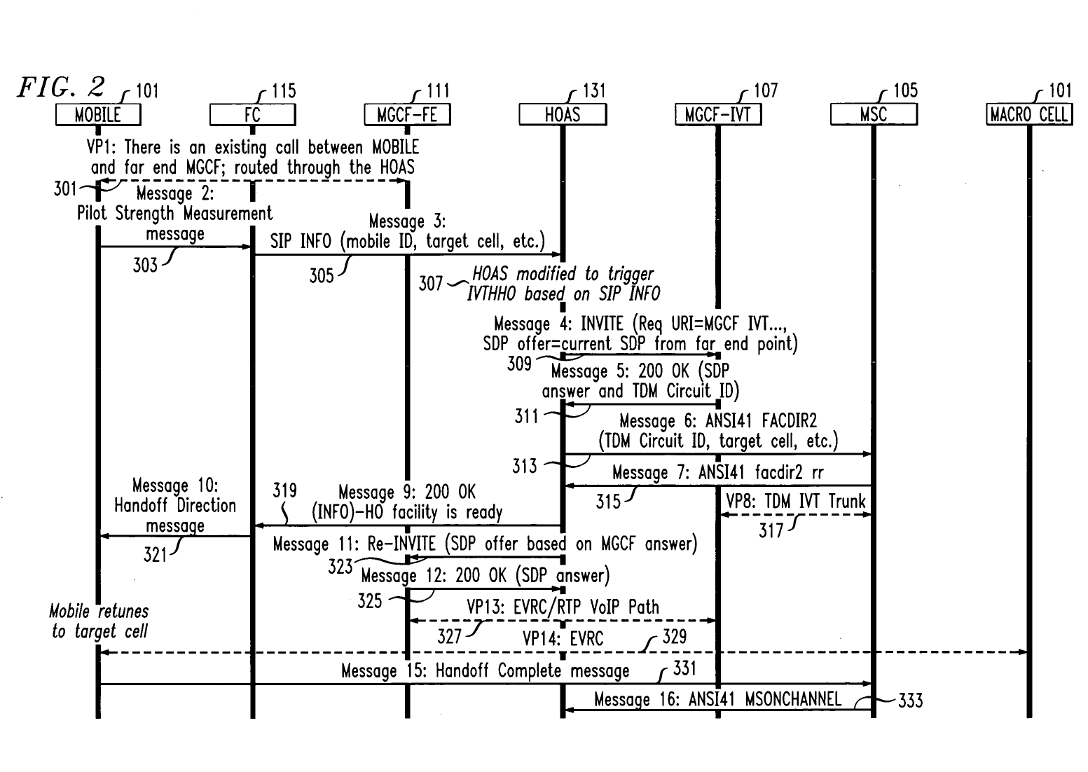

FIG. 2 is a flow chart illustrating one embodiment of the method according to the present disclosure.

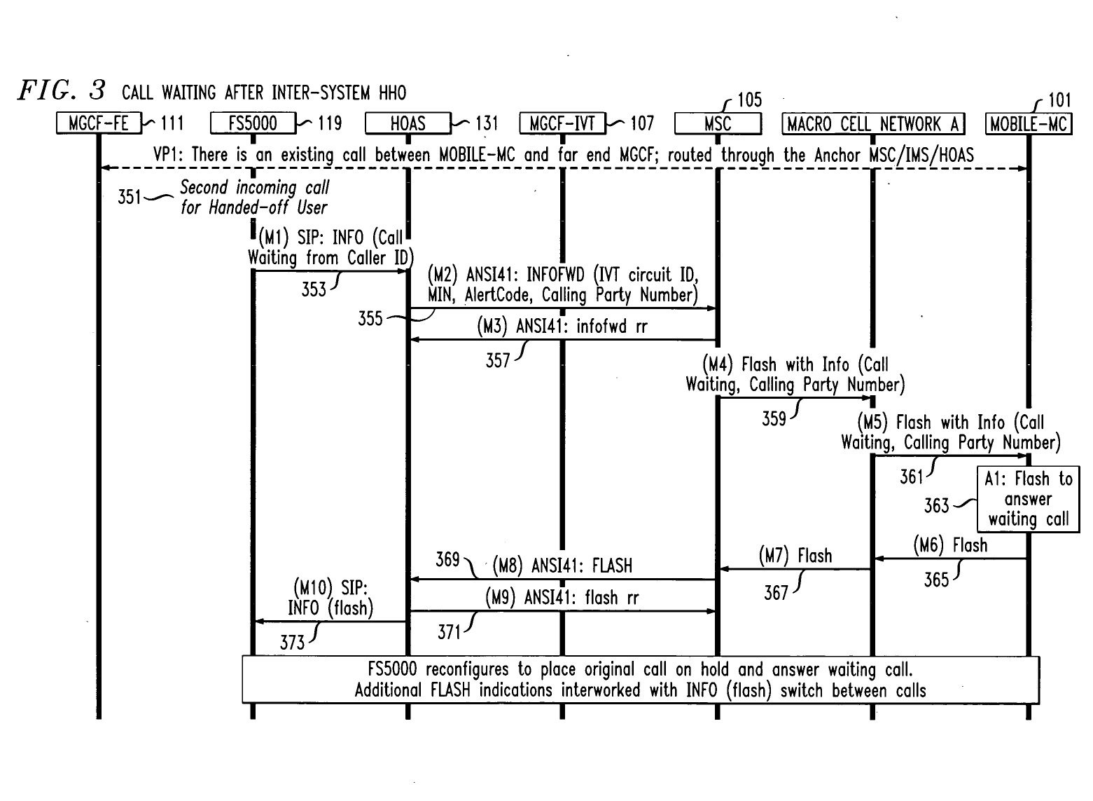

FIG. 3 is a flow chart illustrating one of the supplemental services according to the present disclosure.

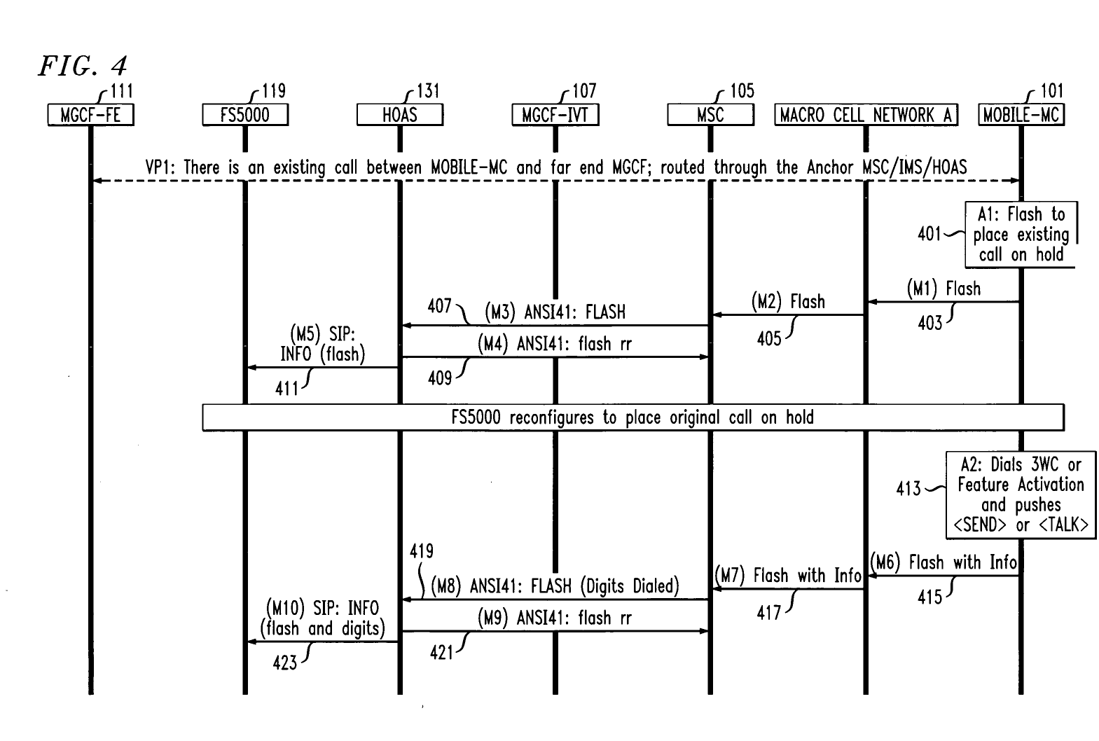

FIG. 4 is a flow chart illustrating another one of the supplementary features according to the method in the present disclosure.

### DETAILED DESCRIPTION

Referring now to the drawings wherein the showings are for purposes of illustrating the disclosed embodiments only and not for purposes of limiting the same. FIG. 1 provides an overall view of a system into which the present disclosure may be incorporated. A communication infrastructure A is shown. The communication infrastructure includes a mobile station 101, a base station transceiver subsystem 103, a legacy based MSC 105, a plurality of media gateways 107, 111, an IP network 109, a Public Switched Telephone Network (PSTN) 113, a base transceiver system 115 and a Home Location Register (HLR) 133. The communication infrastructure A also includes a variety of network elements including a feature server 119, a Call Session Control Function (CSCF) 121, a Home Subscriber Server (HSS) 123, a Mobility Management Application Server (MMAS) 125 and a Hand-Off Application Server (HOAS) 131. It should be understood that this is but one representation of one embodiment of the communications network infrastructure A. The present disclosure could be incorporated in a variety of communication network configurations.

In operation, as described in greater detail below, the presently described embodiments are directed towards supporting the migration of a CDMA mobile from an IMS BTS to a circuit based MSC. In this sense the disclosure describes a solution to the current problem which involves using a CDMA 3G1x voice mobile station through an IMS core network and transferring the call seamlessly to an MSC core network which uses a legacy circuit based solution. Because wireless service providers further plans are to evolve their core network to IMS in order to support VoIP and other multimedia services over Evolution Data Optimized (EV-DO) rev A this is a useful development. Therefore, it is useful to have one core network which supports the 3G1x voice and VoIP over EV-DO rev A. Therefore, it will prevent wireless service providers from relying on two separate core networks. However, when a user leaves the immediate vicinity of the BTS 115 the user will require that the CDMA mobile 101 be able to still be used on the legacy based network. In this sense, it will be necessary for a seamless hand-off to take place.

Continuing on with FIG. 1, this embodiment includes a mobile station 101 which is user equipment. However, other user equipment besides a mobile station shown may be substituted. Other examples of user equipment include, but are not limited to, wireless phones, VoIP telephones, laptop computers, desktop computers, WI-Fl phones, etc. These devices are typical user equipment used to communicate through compatible lines. In this embodiment, the mobile station is a CDMA 3G1x handset which typically communicates through a base station transceiver subsystem 103.

Still referring to FIG. 1, the CDMA 3G1x mobile station 101 as shown is migrating away from the BTS 115 outside of its range. The BTS is connected to the IP network 109. In turn the IP network is connected to the media gateway 111 and the PSTN 113 in order to complete a call. The IP network is also connected to a variety of network elements such as the feature server 119, the CSCF 121, the HSS 123, the MMAS 125, the hand-off application server 131, the short message service center 129, and another gateway 107. Gateway 107 is connected to the legacy circuit based network through an intervendor trunk which connects to the circuit based MSC 105. The circuit based MSC 105 is in communication with the home location register 133 and the base station transceiver subsystem 103.

While a call is taking place, a variety of network elements perform various functions in processing the call. The CSCF 121 may be used to provide session control for the mobile call. It may also be used to regulate bandwidth and maintain Quality of Service (QoS) throughout the call.

The HSS 123 may be used to hold subscriber information for network B. The HSS 123 may have been transferred this information from the HLR 133 directly or via the MMAS 125. The feature server 119 may be used to implement supplementary features such as call waiting and/or three way calling which is described in further detail below. The short messaging service center 129 may be used in order to supply short messaging services for the call.

While the mobile station 101 is receiving a signal from the BTS 115, it is measuring the signal strength in the current network and its neighboring cells. As the mobile station 101 moves further from the BTS the signal will get weaker and the signal from the base station transceiver subsystem 103 will get stronger. Once the signals reach a certain threshold the BTS 115 may decide that a hand-off is appropriate.

The BTS 115 will signal the hand-off application server 131 in order to initiate a hand-off procedure. Internally this hand off procedure will be initiated via a SIP message, for example, info or subscribe/notify. The hand-off application server 131 has been triggered to reconfigure the call and initiate a reservation of the inter-system circuit by sending an invite message to the media gateway 107.

The media gateway 107 reserves an intersystem circuit and signals back to the hand-off application server 131. The hand-off application server 131 may then initiate the inter-system circuit through ANSI-41 standard signaling (as opposed to SIP signaling) to the legacy MSC 105. This circuit between the anchor MSC which is emulated by the IMS and the target MSC 105 is reserved for this hand-off.

The hand-off application server 131 then responds to the BTS 115 indicating that the message was received and that the circuit has been reserved. The BTS 115 in turn signals to the mobile station 101 in order to have it retune to the macrocell in network A. The hand-off application server 131 then simultaneously reconfigures the voice path through the IMS and connects the existing call through network A, the legacy based MSC. In this sense the mobile station 101 has returned to the macrocell and this successful hand-off is signaled from the target MSC 105 back to the anchor MSC, the IMS.

Finally, the call is released by the base station 101 and the MSC 105 signals the call and circuit release back to the IMS. This signal may be communicated via ANSI-41 facrel message. This will in turn release the call path through the IMS as the IMS responds that the call is released to the target MSC 105.

Now referring to FIG. 2 which is a flow chart illustrating one of the embodiments of the method according to the present disclosure. This chart includes the mobile 101, BTS 115, media gateway 111, the hand-off application server 131, another media gateway 107, MSC 105, and the mobile when on the macro network 101. It should be understood that the method may be implemented by a variety of software and hardware configurations. It should also be understood that suitable software/hardware implementing the embodiments of the invention may also be distributed on any and/or all appropriate network elements The method begins with a call that is existing between the mobile and media gateway routed through hand-off application server at 301. During this time the mobile 101 is measuring the signal strength of the neighboring cells and the cell that it is currently on at step 103.

Message 3 is a SIP info message identifying that a hand-off is appropriate. This message is sent from the BTS 115 to the hand-off application server. The message may include a mobile identification which may include an electronic serial number and the target cell and any other information that will enable the hand-off application server 131 to complete the message. This takes place at step 305.

At step 307 the hand-off application server 131 triggers the inter-vendor trunk based on the information that was sent in message 3 at step 305. At step 309, message 4 sent inviting the media gateway to reserve a circuit that will be used for the hand-off.

Message 5 includes 200 OK message at step 311. In this message, the media gateway 107 identifies the reserved circuit and signals back to the hand-off application server 131. Through message 6 these are communicated to the MSC 105 in order to initiate the inter system circuit at step 313. At step 315, the message 7 is sent which is an acknowledgment message from the MSC 105 to the hand-off application server 131.

At step 317, the circuit is reserved between the MSC 105 and the media gateway 107 and is available for traffic. The media gateway 107 which is part of the IMS will act as part of the anchor MSC and the circuit based MSC 105 is the target MSC.

At step 319, message 9, a 200 OK info message is sent from the hand-off application server 131 to the BTS 115. This message indicates that the hand-off request was received and the facility in which to place the hand-off is ready.

At step 321, message 10, the hand-off direction message is sent from the BTS 115 to the mobile station 101. This message includes the target cell information necessary to allow the mobile station 101 to retune to the target cell 101. At message 11 and 12, steps 323 and 325 re-invite and a 200 OK message relayed between the hand-off application server 131 and the media gateway 111 reconfigure the call path from the BTS 115 to the new inter-system circuit trunk. Generally, these messages can be sent simultaneously with message 9. Steps 327 and 329 show the reconfigured packet voice path through the IMS to connect the existing call to the circuit. The hand-off application server 131 then releases the connection towards the BTS 115 in the voice path in the IMS from the original end point to the inter-switch trunk. Finally, message 15 at step 331 assumes a hand-off complete message from the mobile 101 to the MSC 105. MSC 105 then informs the hand-off application server 131 through a standard message that the mobile station is on channel at step 333.

Now referring to FIG. 3 which is a feature service after the inter-system hand-off is completed. In this embodiment, the feature service is call waiting.

The method begins with an existing call between the mobile station 101 and the IMS media gateway routed through the target MSC 105, the IMS network and the hand-off application server 131. At step 351, a second incoming call for the user comes in. This will signal message 1 at step 351, a SIP message from the feature server 119 to the hand-off application server 131, identifying call waiting from the caller ID.

At step 355, message 2 is sent, a standard ANSI-41 message from the hand-off application server 131 to the circuit MSC 105. The hand-off application server 131 has been monitoring the signal session and acting as a proxy for the user end point. As such, when this message received from the user end point, the hand-off application server 131 translates the message to a standard ANSI-41 inter-switch message. This provides an indication to the target MSC 105 that there is a signal to be provided to the mobile-101. This shows a proxy interworking of SIP signals with standard ANSI-41 signals. At message 3, at step 357, the MSC 105 acknowledges the receipt of the message to the hand-off application server 131.

At message 4, at step 359, the MSC forwards the message out to the macrocell indicating the information which may include the calling party number and any other caller ID information. The message is sent from the macrocell to the mobile 101 through message 5 at step 361.

At step 363, the user hits the flash button in order to answer the call waiting. This will place the existing call in hold and accept the new incoming call; a flash message 6 is signaled at step 365. At step 367 that flash message 6 is sent from the macrocell to the MSC 105. That flash message is in turn relayed from the MSC 105 to the hand-off application server 131 acting as the anchor MSC in message 8 at step 369. Message 9 is a standard ANSI-41 message return acknowledging that the hand-off application server 131 receives the flash message. At step 371, hand-off application server 131 sends the message to the feature server 119. The hand-off application server 131 acts as an end point proxy which translates the ANSI-41 standard message to SIP info, containing the end user flash indication to the feature server 119. The feature server 119 reconfigures the call to place the existing session on hold and connects the new incoming message through the existing voice path. Additional flash indications interworked with the info flash toggle between the two calls.

Now referring to FIG. 4 which is an additional supplemental feature, three-way calling. Also known as mid-call feature activation, this feature will happen after the hand-off is complete and the mobile is servicing the call through the macrocell. This method also begins with an existing call between the mobile unit 101 on the macrocell and the far end media gateway 111 routed through the target MSC 105, the IMS network and the hand-off application server 131.

At step 401, the user hits the flash button in order to place the existing call on hold. A flash signal is indicated at step 403 through message 1. Message 1 is a flash message sent from the mobile 101 to the macrocell. Message 2 is the macrocell sending a flash message at step 405 to the MSC 105. Message 3 at step 407 is the flash message being sent from the MSC 105 to the hand-off application server 131. The flash message is now in ANSI-41 standard flash message. At message 4, the hand-off application server acknowledges through ANSI-41 that the flash message was received at step 409.

Message 5 is a SIP info flash message at step 411. The hand-off application server 131 interworks the incoming flash message to a SIP message with flash indication and forwards it to the feature server 119. The feature server 119 reconfigures to place the original call on hold.

At step 413, the user dials the next number and pushes send or talk. At message 6, at step 415 this information is sent with a flash message from the mobile station 101 to the macrocell. Message 7 is the flash with info message that is sent from the macrocell to the MSC 105 at step 416. Message 8 is an ANSI-41 standard message of flash and the digits dialed. At step 419 this message is sent from the MSC 105 to the hand-off application server 131. At step 421 message 9 it is an acknowledgement of the message that is sent from the hand-off application server 131 back to the MSC.

Message 10 at step 423 is a SIP info message with flash and the digits dialed. This message is sent from the hand-off application server 131 to the feature server 119. The feature server then reconfigures the call in order to connect or utilize the three-way calling feature on the mobile station.

The above description merely provides a disclosure of particular embodiments of the claimed invention and is not intended for the purposes of limiting the same thereto. As such, this disclosure is not limited to only the above-described embodiments. Rather, it is recognized that one skilled in the art could conceive alternative embodiments that fall within the scope of the invention.

We claim:

1. A method for handoff of a cell division multiple access mobile from an internet protocol based network to a circuit mobile switching center comprising:
determining whether a handoff is appropriate based, at least in part, upon signal strength of a call for a mobile unit;
sending a message indicating a mobile identification of said mobile unit and a target cell;
locating a circuit identification of a circuit that is available to accept a handoff;
allocating said circuit; and reconfiguring the mobile unit to a cell division multi access network via said circuit.

2. The method according to claim 1, wherein said mobile identification is an electronic serial number.

3. The method according to claim 1, wherein signal strength includes monitoring cells on a neighbor list.

4. The method according to claim 1 further comprising maintaining an active call while said handoff is completed.

5. The method according to claim 1 wherein said mobile unit is idle roaming.

6. The method according to claim 1 wherein said mobile is roaming.

7. The method according to claim 1 further comprising performing supplemental features through an anchor mobile switching center.

8. The method according to claim 7 wherein said supplemental features include three way calling.

9. The method according to claim 7 wherein said supplemental features include call waiting.

10. The method according to claim 7 wherein said supplemental service include short message service.

11. The method according to claim 7 wherein said message is a session initiation protocol message.

12. The method according to claim 1 further comprising:
releasing said call once a call session is complete; and
signaling said release.

13. A system for handoff of a cell division multi access mobile from an internet protocol based network to a circuit mobile switching center comprising:
a handoff application server that implements a handoff procedure including reconfiguring a call through an internet protocol network to connect to an intersystem circuit and initiating a reservation for a circuit by sending an invite message; and
a media gateway configured to receive said invite message from said handoff application server, reserve said circuit for said handoff and signal back to said handoff application server that the reservation is complete.

14. The system according to claim 12, further comprising a base station that receives measurement messages and based at least in part on a threshold sends a signal to said handoff application server that initiates said handoff procedure.

15. The system according to claim 12, further comprising a feature server configured to facilitate supplemental features to said call.

16. The system according to claim 14 wherein said supplemental features include call waiting.

17. The system according to claim 14 wherein said supplemental features include three way calling.

18. A method for facilitating a handoff procedure from an internet protocol based network to a legacy mobile switching center based network comprising:
monitoring radio signals strength of neighboring cells and a communication cell;
making a determination for a handoff based at least in part on said radio signals strength;
signaling a handoff initiation message to a handoff application server;
reserving a circuit for said handoff, said circuit being between an anchor mobile switching center in an internet protocol multimedia subsystem and a target mobile switching center in an legacy mobile switching center; and
reconfiguring a path though said circuit.

19. The method according to claim 17 wherein the determination is based at least in part on said radio signal strength and predetermined threshold.

20. The method according to claim 17 wherein said handoff initiation message is a session initiation protocol message.

21. The method according to claim 17 wherein said path is a voice path.
